(19) United States
(12) Patent Application Publication
(10) Pub. No.: US 2026/0053682 A1
(43) Pub. Date: Feb. 26, 2026

(54) MOBILE HOSPITAL WITH MODULAR STORAGE AND DEPLOYMENT

(71) Applicant: Planned Systems International, Inc., Arlington, VA (US)

(72) Inventors: Chiang H. Ren, Centreville, VA (US); Thomas J. Berti, Lusby, MD (US)

(21) Appl. No.: 19/286,385

(22) Filed: Jul. 31, 2025

Related U.S. Application Data
(60) Provisional application No. 63/685,507, filed on Aug. 21, 2024.

(51) Int. Cl. A61G 3/00; B60R 11/00

(52) U.S. Cl. CPC A61G 3/001; B60R 2011/0028; B60R 2011/0075; B60R 2011/0084

(57) ABSTRACT

Embodiments described herein relate to modular systems for deploying equipment. In one embodiment, a modular system for storing and deploying provisioned components within a vehicle is disclosed. The modular system includes a container having (i) an interior space for accommodating a provisioned component, (ii) a component connector for attaching the provisioned component to the interior space, (iii) a modular mount integrated with an outer backwall of the container, and (iv) a utility aperture. The modular system also includes a modular connector for securing the container to the vehicle via the modular mount.

### CROSS-REFERENCE TO RELATED APPLICATIONS

This application claims the benefit of U.S. Provisional Application No. 63/685,507, filed on Aug. 21, 2024, which is herein incorporated by reference in its entirety.

### TECHNICAL FIELD

The subject matter described herein relates, in general, to modular storage systems and, more particularly, to a mobile hospital container with a modular system for medical equipment.

### BACKGROUND

Systems for storing and deploying medical equipment are typically designed for use in stationary hospital environments. These systems often utilize fixed equipment, storage units, and mechanical arms to organize and position equipment for clinical use. While such technologies can provide secure storage and facilitate access to medical devices, they are generally intended for settings with ample space and stable conditions. As a result, these solutions do not address the unique challenges of compact, reconfigurable storage or rapid deployment of medical equipment in environments subject to movement or space limitations. Existing designs are not optimized for applications where equipment must be frequently repositioned, securely stowed, and quickly accessed within a confined and dynamic setting. Additionally, the specific challenges of mobile platforms can include external forces from accelerations, vibrations from uneven surfaces, and so on. Thus, effectively securing sensitive equipment and preventing damage can be a difficult task within the context of a mobile platform.

### SUMMARY

The embodiments described herein are directed to modular storage systems for various equipment (e.g., medical equipment) that facilitate a secure and reconfigurable deployment. As mentioned above, systems for storing and deploying medical equipment are designed for use in stationary environments where damage from vibrations and external movements are not generally a consideration. Thus, these systems are not well-suited for mobile deployment and do not generally consider configurations that permit rapid reconfiguration and deployment in dynamic settings since they tend to be limited to static built-in contexts.

Accordingly, in various arrangements, a mobile healthcare platform includes a modular container system that provides for selectively mounting containers to a ceiling, wall, and/or floor of a mobile unit, allowing staff to rearrange medical equipment as needed to support different medical procedures or workflows. In one embodiment, containers house deployment mechanisms for medical equipment, such as mechanical arms, lowering platforms, or flexible tubes that enable rapid and precise positioning of medical devices for use and secure retraction for transport. The reconfigurable nature of the system allows for dynamic and easy adaptation to various medical needs and procedures, evolving clinical standards, and routine maintenance, thereby ensuring optimal use of limited space that supports a wide range of medical procedures in a mobile environment. In this way, the modular system improves over existing approaches by providing a flexible solution for reconfiguring a medical suite, whether mobile or stationary.

In one embodiment, a modular system for storing and deploying provisioned components within a vehicle is disclosed. The modular system includes a container having (i) an interior space for accommodating a provisioned component, (ii) a component connector for attaching the provisioned component to the interior space, (iii) a modular mount integrated with an outer backwall of the container, and (iv) a utility aperture. The modular system also includes a modular connector for securing the container to the vehicle via the modular mount.

In another embodiment, an apparatus for storing and deploying provisioned components is disclosed. The apparatus includes a container defining a utility aperture and an interior space for accommodating a provisioned component. The apparatus also includes a component connector for attaching the provisioned component to a surface of the container. The apparatus also includes a modular mount integrated with an outer backwall of the container. The apparatus also includes a modular connector for securing the container to a structure via the modular mount. The apparatus further includes a modular connector for securing the container to a structure via the modular mount.

In yet another embodiment, a device for storing and deploying provisioned components within a vehicle is disclosed. The device includes a container defining a utility aperture and an interior space for accommodating a provisioned component. The container has a component connector for attaching the provisioned component to the interior space and a modular mount that is at least semi-continuously integrated along an exterior surface of the container and defines at least one channel. The device also includes a modular connector having at least one rail that mates with the at least one channel for detachably securing the container to the vehicle via the modular mount.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one example of a mobile vehicle configured with a modular system.

FIG. 2A illustrates one example of a modular system that includes a container for a provisioned component.

FIG. 2B illustrates an embodiment of a modular system with a first type of modular connector.

FIG. 2C illustrates another embodiment of a modular system with a second type of modular connector.

FIG. 2D illustrates yet another embodiment of a modular system with a different configuration of a modular connector.

FIG. 3A illustrates an arm for a provisioned component of a mobile hospital in a retracted position.

FIG. 3B illustrates an arm for a provisioned component of a mobile hospital in an extended position.

FIG. 3C illustrates various examples of attachments for attaching a provisioned component to an arm.

FIG. 4A illustrates a modular container with a platform for a provisioned component in a retracted position.

FIG. 4B illustrates a modular container with a platform in a lowered position.

FIG. 4C illustrates various examples of component connectors for attaching a provisioned component to a platform within a modular container.

FIG. 5A illustrates a reel for securing a provisioned component within a container.

FIG. 5B illustrates a reel for a provisioned component in an extended position.

FIG. 5C illustrates various connector types for attaching a provisioned component to a reel.

FIG. 6 illustrates example layouts of modular containers within different portions of a vehicle configured as a mobile hospital.

### DETAILED DESCRIPTION

Various embodiments associated with a modular container system are disclosed. As noted above, conventional systems for storing and deploying medical equipment may be designed for use in stationary hospital environments and thus are not suitable for rapid reconfiguration and deployment in dynamic settings. That is, components within these systems are not easy to remove and replace as the connections generally leverage single-use fasteners, which can be cumbersome to uninstall. Moreover, the utility connections that support electronics (e.g., medical equipment) are often statically located and cannot be moved to adapt for mounting in different locations. Therefore, these systems tend to be inflexible and further do not account for specific difficulties of a mobile context, such as vibrations, and so on.

Accordingly, in one approach, a modular system is provided that includes containers that can be modularly mounted to a surface and connected with utilities, thereby allowing staff (e.g., clinical staff) to rearrange provisioned components (e.g., medical equipment) as needed to support different medical procedures or workflows. For example, within the context of a mobile medical facility housed within a vehicle, the modular system permits staff to reprovision the selection of medical equipment and the specific layout of medical equipment. That is, some containers house deployment mechanisms for medical equipment such as mechanical arms, lowering platforms, flexible tubes, etc., that enable rapid and precise positioning of medical devices for use and secure retraction for transport. The reconfigurable nature of the system allows for dynamic and easy adaptation to various medical needs and procedures, evolving clinical standards, and routine maintenance, thereby ensuring optimal use of limited space supporting a wide range of medical procedures in a mobile environment or a static location that can be dynamically adapted for different uses.

As additional context, consider that mobile hospital environments will be crucial to addressing the rural healthcare crisis in the United States (U.S.) and shortages in healthcare availability across the world. Since 2005, nearly 200 rural hospitals in the U.S. have closed. The ten most impacted states from 2005 to 2025 stretch from California to Florida: Alabama (7 closures), Florida (8 closures), California (9 closures), Kansas (9 closures), Oklahoma (10 closures), Missouri (10 closures), Georgia (10 closures), North Carolina (10 closures), Tennessee (14 closures), and Texas (29 closures). In addition to the hospital closures many communities have faced, which have suddenly forced people to drive many miles to the next nearest hospital, there are also many rural communities across the U.S. with hospital-level healthcare needs that never garnered the investment of hospital construction. Over 57 million Americans are now impacted by this decline in rural health, and the crisis has worsened following the financial stresses caused by the COVID-19 pandemic. While the COVID-19 pandemic placed demands on emergency resources, it collapsed demand relating to other hospital resources. For example, the aging population in rural America has led to lower birth rates in some regions, resulting in the closure of many obstetrics departments. The financial stresses faced by rural hospitals operating under the fee-for-service model, including the challenges of recovering investments in specialty staff and infrastructure, have been studied. Additionally, the environmental stresses faced by rural hospitals due to shifting public policies have been examined.

The Government Accountability Office (GAO) has reported on federal efforts to address the rural health crisis, but perfect solutions have yet to emerge. Across the world, the shortages in hospitals and healthcare services vary by region, but the COVID-19 pandemic has shown that these shortages even exist in developed nations. In less developed nations, the demand for hospital quality service is continuous across broad geographic regions. Early U.S. attempts to help such regions with the hospital ships Mercy and Comfort have achieved mixed results, as the presence of these hospital ships caused population migration issues through Africa. Different countries have developed deployable mobile treatment centers; however, these systems are either focused on disaster response with patient triage and stabilization or community screening with equipment geared for specific illnesses. Thus, a mobile hospital environment provides many advantages to addressing the rural health crisis.

Accordingly, in one approach, a mobile hospital is provided on a vehicle. For example, the vehicle can be a passenger, cargo, or industrial van that is street legal on roads in the U.S. In alternative examples, the mobile hospital is provided on other mobile platforms such as larger vehicles, planes, helicopters, and even boats. In any case, as noted above, the mobile platform provides many advantages such as 1) storage of a full range of hospital-grade medical equipment, 2) storage of medical equipment in a manner that optimizes freedom of motion for clinical staff, 3) rapid deployment of medical equipment into positions that support medical procedures, 4) rapidly storage of medical equipment after completion of procedures, 5) modularity of the locations of medical equipment to support various medical procedures, and 6) installation of different types of equipment connections to hold different makes and models of medical equipment.

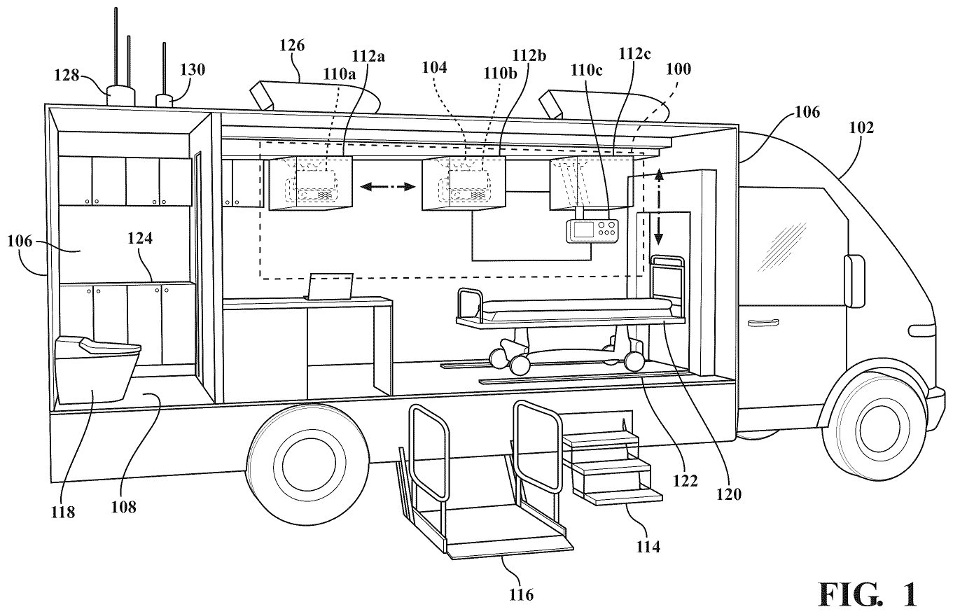

Referring now to FIG. 1, an example of a modular system 100 (herein referred to as the system 100) is shown. As shown in FIG. 1, the system 100 is provided within the context of a mobile hospital that is provided on a vehicle 102. However, as noted above, it should be understood that the system 100 can be provided on other mobile platforms and/or for other purposes (e.g., mobile vet, mobile dentist, etc.). Moreover, it should be understood that the system 100 can be provided in a stationary hospital or other healthcare settings. For example, the system 100 can be provided within a building (e.g., a stationary hospital, an urgent care or emergency facility, a doctor's office, etc.).

In any case, the system 100 can be provided as part of different types of structures. For example, in the illustrative example of FIG. 1, the structure is a mobile hospital with a ceiling 104, sidewalls 106, and a floor 108. As shown, the ceiling 104, the sidewalls 106, and the floor 108 make up the cargo space of the vehicle, which may be a passenger-style van. In some examples, the vehicle is around 8.5 feet wide and 13.5 feet high, making the vehicle 102. However, in instances where the mobile hospital is provided on other types of vehicles, the mobile hospital can have other dimensions (e.g., as a trailer of a tractor-trailer). Moreover, as noted above, the system 100 can be provided in a stationary structure. In various examples, the structures can be a ceiling, sidewalls, and a floor of a building (e.g., a stationary hospital, a doctor's office, etc.).

In any case, the system 100 includes equipment, such as medical equipment, that clinical staff (e.g., doctors, nurses, etc.) can use to evaluate and treat patients. Accordingly, in one embodiment, the system 100 includes provisioned components 110. As shown in FIG. 1, the system 100 includes three provisioned components 110a, 110b, and 110c. However, it should be understood that there may be more or fewer containers 112 with provisioned components 110 than illustrated in the present example. As used herein, the term “provisioned component” refers to equipment, devices, instruments, or apparatuses that are intended to be stored within the system 100 and are configured for deployment and use in a medical, clinical, or healthcare environment. The term “provisioned component” encompasses, in various configurations, associated accessories, attachments, or subcomponents for the operation of such equipment, and may include both powered and non-powered devices. Provisioned components 110 may vary in size, weight, power requirements, and intended use, and are selected based on the clinical needs of the mobile or stationary hospital environment.

Examples of the provisioned components 110 include defibrillators, ventilators, X-Ray machines, EKG machines, ultrasound machines, etc. It should be appreciated that while medical equipment is generally described along with the current discussion, other types of equipment may be provisioned in other contexts (e.g., electronics repair, firefighting, etc.).

Table 1 lists various examples of provisioned components 110, including additional characteristics that identify the intended use, average specifications (e.g., dimensions, weight, power, and heat output), and the potential location within the vehicle. As shown in FIG. 1 and as described in further detail below, the provisioned components 110, in one arrangement, are attached to the ceiling 104. However, in other examples, the provisioned components 110 are attached to one or more of the sidewalls 106 or the floor 108. It should be understood that in some arrangements, one or more provisioned components 110 can be attached to the ceiling 104 and/or the sidewalls 106 and/or the floor 108 in varying combinations. Moreover, while a medical context is described in relation to the system 100, it should be appreciated that the system 100 can be implemented within further contexts, which implement different types of provisioned components than those described herein. In any case, one example of provisioned components is set forth in relation to Table 1.

TABLE 1
Examples of provisioned components, including intended use, specifications,
and example storage locations associated with a medical context.

| | | Average | |
|---|---|---|---|
| | | Dimensions, | |
| | | Weight, Power, | Potential Mobile |
| Equipment | Description | Heat Output | Deployment Location |
| Defibrillator | Used to treat cardiac | 13″ × 16″ × 10″ | Detachably mounted to |
| | arrhythmias using an | 20 lbs | the ceiling and lowered |
| | electric current to the heart | N/A | over the patient's chest |
| | | N/A | or brought to patient on |
| | | | the ground |
| Patient Monitor | Used for monitoring | 8″ × 6″ × 4″ | Positioned so that |
| | cardiac, hemodynamic, | 3 lbs | sensors reach patient |
| | respiratory, and other | 75 W | and a physician has a |
| | patient functions, | Low | clear view of the |
| | childbirth, body temp, etc. | | monitor |
| Ventilator | Used to move air in and | 8″ × 10″ × 5″ | Lowered until |
| | out of patient lungs to | 15 lbs | ventilation tube can |
| | assist patient who is unable | 50 W | reach the patient and the |
| | to breathe properly | Low | physician can see C0₂ |
| | | | sensors |
| EKG/ECG Machine | Used to produce an | 4″ × 15″ | Stored above the patient |
| | electrogram of the heart | <1 lb | bed |
| | | Low | |
| | | Negligible | |
| Ultrasound | Used to create an image of | 3′ × 1′ | Secured to the ceiling |
| | internal body structures to | 40 lbs | with the sensor and |
| | measure characteristics or | 500 W | screen lowered for |
| | generate an informative | Medium | patient access |
| | audible sound | | |
| X-Ray Machine | Used for visualizing bone | 10″ × 10″ × 20″ | Secured to the ceiling |
| | structures, especially | 40 lbs | and deployed over parts |
| | during procedures | 5 kW | of the body being |
| | | High | treated |
| Electrosurgical Unit | Used to cut, coagulate, | 15″ × 12″ × 5″ | Secured to the ceiling |
| | desiccate, or fulgurate | 11 lbs | and lowered to a height |
| | biological tissue | 600 W | at which a physician can |
| | | Medium | reach the controls and |
| | | | the instrument can reach |
| | | | the patient |
| Suction Devices | Used to clear the airway of | 7″ × 13″ × 13″ | Secured to ceiling with |
| | blood, saliva, vomit, | 9 lbs | suction pipe connected |
| | and/or other secretions to | N/A | to a waste management |
| | allow a patient to breathe | N/A | unit |
| Examination and | Focused lighting with | 1′ in diameter | Mounted to ceiling and |
| Surgical Lighting | varying intensity that can | 2 lbs | lowered over patient |
| | be moved over the region | 10 W LED | |
| | of the body being treated | Negligible | |

In some instances, especially in arrangements in which the system 100 is provided in a mobile environment, the provisioned components 110 may be at risk of damage because of aspects of the environment. For example, when the system 100 is provided in a mobile environment, movement of the mobile environment may cause clinical staff, patients, or other equipment or structures to contact and damage the provisioned components 110. Moreover, it may be advantageous to store the provisioned components 110 when not in use. Accordingly, in one arrangement, the system 100 includes one or more containers 112 for storing and/or protecting one or more provisioned components 110. An example container 112 is shown in FIG. 1.

In one embodiment, the container 112 has at least five closed sides with a sixth side that is a door closure that accommodates a provisioned component 110. Of course, further configurations of the sides are possible in various configurations. That is, in at least one arrangement, the sixth side may be left as an opening without a discrete closure. In still further arrangements, the container 112 may include four closed sides and two sides that are arranged as closures. Thus, while five closed sides are generally described, the general spirit of the present approach can encompass additional arrangements of closures and openings.

In one example, the container 112 is about 12-18 inches wide, 16-30 inches long, and 24 inches deep. These dimensions are suitable for housing most makes and models of medical equipment to be used in the system 100. However, it should be noted that the container 112 can have other dimensions suitable for housing other types of equipment. Thus, the container 112 may be provided in different sizes to accommodate different classes of equipment, but is generally, in at least one approach, a multiple in size of a base container so that the containers fit together in the connector rails without wasted space.

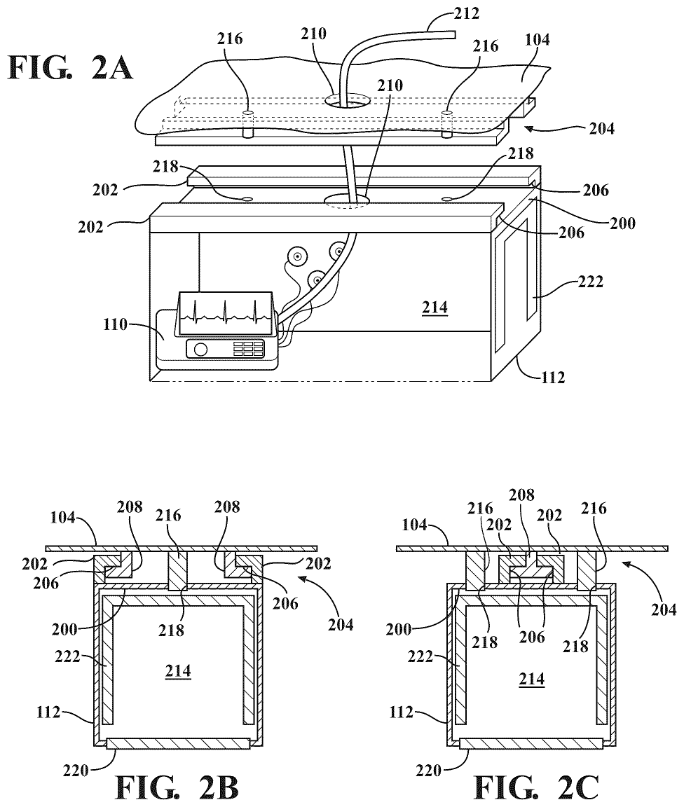

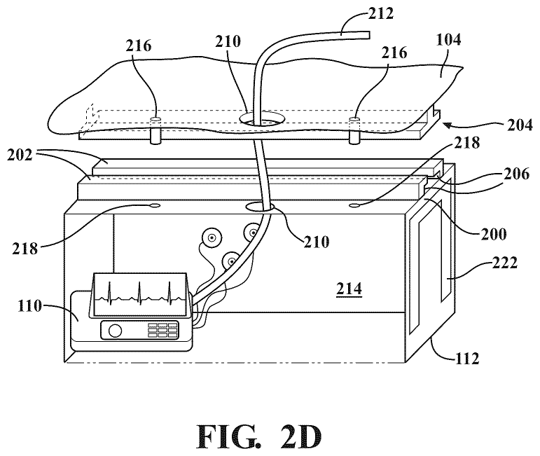

Additionally, the container 112 can be formed of lightweight material (e.g., aluminum, plastic, etc.) that is strong enough to withstand road stresses and deployment operations. In any case, the system 100 includes one or more other components configured to detachably secure the containers 112 in combination with the provisioned components 110 to the vehicle 102 or a stationary hospital environment. As a result, the configuration of containers 112 and provisioned components 110 is wholly modular and customizable. The containers 112 and provisioned components 110 can be arranged in different sequences and configurations according to the needs of the current deployment, the needs of the clinical staff, the type of mobile or stationary hospital environment, procedures to be performed, maintenance of the provisioned components 110, etc. In one arrangement, for example, as shown in FIG. 1 and described in further detail in connection with FIG. 2A, containers 112 and provisioned components 110 are detachably secured to the ceiling 104 via a sliding mechanism. In this manner, clinical staff or equipment technicians can slide the containers 112 with the provisioned components 110 along the ceiling 104 in different arrangements according to various needs. It should be noted that the connector system may be arranged in a longitudinal arrangement along the length of the vehicle 102, across a width of the vehicle 102, or using a combination of arrangements, which can be selected based on the deployment. Further details of the container 112 will be described below in connection with FIG. 2A.

With continued reference to FIG. 1, in arrangements in which the system 100 is provided on a vehicle 102, the vehicle 102 can transport clinical staff to a service location (e.g., a location at which patients need care). At the service location, if necessary, the vehicle 102 can plug into local power, connect to a local outdoor faucet, connect with pressurized air, and potentially connect to a hard-wired Internet connection. The vehicle 102 may also include other components. For example, the vehicle 102 can include stairs 114 and a lift 116 for entry to the vehicle 102 for able-bodied people, handicapped people, and ambulatory wheelchair users. The lift 116 can be compliant with the Americans with Disabilities Act (ADA) and can be a stowable under-chassis lift with a wheelchair-accessible path to a toilet 118. With the wheelchair lift 116 stowed and an access door to the vehicle 102 opened, the vehicle 102 is able to accept a stretcher that, in one embodiment, has custom collapsible legs. Once inside, a patient can be easily transported to a bed 120. Around the bed 120, trays adjacent to the bed 120 can be pulled out to hold small tools and equipment for procedures. The bed 120 can roll along a track 122 for different procedures, lower for patient access, and tilt for different procedures. Additionally, the hospital environment includes a multi-purpose sink 124 and an area for microscopy analysis and conducting real-time lab tests. Moreover, in one arrangement, the vehicle 102 can include an HVAC system 126 and one or more antennas (e.g., a SatCom antenna 128 and a cellular antenna 130).

As mentioned above, in embodiments in which the system 100 is provided in a mobile or stationary environment, the containers 112 and provisioned components 110 can be attached to the ceiling 104, the sidewalls 106, and/or the floor 108 of the environment. Moreover, as mentioned above, the arrangement of the containers 112 and provisioned components 110 is modular and thus fully customizable. In one embodiment, for example, as shown in FIG. 1, the containers 112 with the provisioned components 110 are slidably attached to a modular connector (e.g., a rail), described in further detail below, which may be provided on the ceiling 104, the sidewalls 106, and/or the floor 108. In one arrangement, clinical staff can slide the containers 112 onto and off of the modular connector in order to arrange the containers 112 with the provisioned components 110 according to the needs of the patient, the clinical staff, for routine maintenance, or any other factors associated with a customized arrangement of equipment. Further details of the containers 112 and the components used to attach the containers 112 and provisioned components 110 in a modular and deployable manner will now be described with reference to FIGS. 2A-5C, which illustrate various attachment components for detachably securing containers 112 and provisioned components 110 to the mobile or stationary environment.

Referring now to FIG. 2A-2D, FIGS. 2A-2D illustrate one embodiment of a modular attachment system for containers 112 and provisioned components 110. FIG. 2A illustrates one example of a provisioned component 110 stored in a container 112. The container 112 defines multiple sides, including a backwall with inner and outer sides, as shown by outer backwall 200. In one arrangement, the outer backwall 200 faces the ceiling 104 of the environment (i.e., the vehicle). However, it should be understood that, in other arrangements, the outer backwall 200 can face a sidewall 106 of the environment when the container 112 and provisioned component 110 are detachably secured to the sidewall 106. Similarly, in other arrangements, the outer backwall 200 can face a floor 108 of the environment when the container 112 is detachably secured to the floor 108. While the description of FIGS. 2A-5C will reference the container 112 and the provisioned component 110 detachably mounted to the ceiling 104; it should be understood that the following description also applies to other arrangements associated with walls and the floor.

In any case, with continued reference to FIGS. 2A-2D, the container 112 can include a modular mount 202 for modularly attaching the container 112 to the ceiling 104. Contrariwise, the ceiling 104 includes a modular connector 204 that interfaces with the modular mount 202 for securing the container 112 to the vehicle 102 via the modular mount 202. In one arrangement, the modular mount 202 is integrated with the outer backwall 200. For example, the modular mount 202 can be formed within or as part of the container 112 as a unified structure. In another example, the modular mount 202 can be a separate structure that is attached to the container 112. In any case, in one embodiment, the modular mount 202 includes recessed channels 206, and the modular connector 204 includes one or more rails 208 that mate with the recessed channels 206.

For example, as shown in FIG. 2B, the modular mount 202 includes two recessed channels 206 (e.g., a dual channel), and the modular connector 204 includes two rails 208 (e.g., L-shaped rails) that mate with the two recessed channels 206. In another example, as shown in FIG. 2C, the modular mount 202 includes two recessed channels 206, and the modular connector 204 includes one rail 208 (e.g., a T-shaped rail) that mates with the two recessed channels 206. In yet another example, the modular mount 202 can define a single channel 206 for receiving at least one modular connector 204. In any case, in one embodiment, the modular mount 202 is continuous along the outer backwall 200, as shown in FIGS. 2A-2D. However, in another embodiment, for example, as shown in FIG. 2D, the modular mount 202 can be semi-continuous (e.g., can have gaps) along the outer backwall 200, which may provide for attaching the container at intermediate locations along the length in place of sliding the container in from one end of the rail 208. Similarly, the modular connector 204 can also be continuous or semi-continuous along the ceiling 104. In any case, the containers 112 with the provisioned components 110 can slide, as mentioned above, along the modular connector 204 via the modular mount 202 into various locations.

With continued reference to FIGS. 2A-2D, in one embodiment, the container 112 and provisioned component 110 can be fixed into place along the modular connector 204 via a securement system that includes a pin or other fastener. Accordingly, in one embodiment, the container 112 and/or the modular connector 204 includes one or more pins 216 and defines one or more pin apertures 218. The pins 216 can be spring-loaded pins 216 that insert into the pin apertures 218 to lock the container 112 into place along the modular connector 204. The pins 216 and the pin apertures 218 can be provided on either the container 112 and/or the modular connector 204 in any arrangement or on the ceiling 114 with an aperture within the backwall 200. When the spring-loaded pins 216 engage from the container 112 into an aperture 218 in the ceiling, the pins 216 may further included a pull or other mechanism that permits a user to pull on the pins 216 from within the container 112. In any case, the clinical staff can push the pins 216 out of the pin apertures 218 to allow selective locking and movement of the container 112 and provisioned component 110 along the modular connector 204. In another embodiment, for a different approach to securing the containers 112, the containers 112 can be screwed into place at a fixed location along the modular connector 204, quick-release skewers, integrated latches, opposing releasable cleats, and so on.

In some instances, particularly in instances where the system 100 is provided within a mobile environment, the mobile environment may be subject to movement and thus vibration. Such movements and vibrations may cause damage to the containers 112 and/or the provisioned components 110 or can cause issues with the calibration of different provisioned components 110. Accordingly, in at least one arrangement, the modular connector 204 and/or the modular mount 202 may be provided with integrated shock dampening, including rubberized spacers affixed to the modular connector 204 along the rails 208 or rubberized coatings along contacting surfaces (e.g., between the ceiling 104 and the modular mount 202). It should be further appreciated that the provisioned components may be mounted within the containers 112 using isolation mechanisms that provide a standoff from the container and which may further integrate vibration-damping components, such as springs, rubberized spaces, counterweights, and so on.

Further details of the container 112 will now be discussed with reference to FIGS. 2A-2D. In one embodiment, the container 112 defines a utility aperture 210 and an interior space 214 defined by the walls of the container 112. In one example, the utility aperture 210 is an opening in the container 112 for passing at least one utility 212 (e.g., one or more cables or conduits) into the interior space 214. The utility 212 can be an electric utility, a water utility, a pneumatic utility, a communication utility (e.g., fiber optic or Ethernet (e.g., CAT-8) cabling), HVAC, and so on. In some examples, the utility 212 is in the form of a wire, cord, or other conduit that extends through the interior space 214, passes through the utility aperture 210 and through a corresponding utility aperture 210 in the ceiling 104, and connects to a service opening (e.g., an outlet) on the vehicle 102 or the stationary environment. In various arrangements, the utility 212 may be provided as a single combined cable/conduit or as individual services. Moreover, in an additional arrangement, the utility 212 may include automatic shutoffs for unused services and may further include quick connects for quickly and efficiently attaching to container-side utility connectors. In yet further arrangements, the at least one utility 212 may include HVAC connections for maintaining an internal environment of the container 112. That is, the utility may provide heated or cooled air or liquid that can be used within the container 112 to maintain an environment for the particular provisioned component 110. In yet further configurations, the utility 212 is provided as one or more integrated connections within the container 112 such that one or more receptacles or other connectors are provided on, for example, the inner backwall 200 of the container 112, which may connect with the utility 212 via one or more cables provided through the aperture 210 or via direct connections (not illustrated) on the outer backwall 200.

Moreover, in one arrangement, the container 112 includes a selectively movable closure 220 (e.g., a door) for enclosing the provisioned component 110 within the interior space 214 (e.g., to prevent accidental release of the provisioned component 110) and through which the provisioned component 110 can be deployed from the container 112 for use by the clinical staff. Examples of closures include sliding doors, hinged doors, folding doors, etc. It should be appreciated that the separate types of movable closures provide different advantages, such as space saving, securement, better access for large items, etc. In one example, the closure 220 is a sliding door that slides along a length of the container 112 so that the closure 220 does not protrude into the working environment of the clinical staff. The sliding closure may provide for opening one-half of the available length when using rigid doors or a greater percentage of the length if, for example, using a rolling door-style closure. The closure 220 can be motorized or manually operated. Furthermore, the closure can be made of metal, glass, plexiglass, textile, or another suitable material.

In one arrangement, the container 112 can include interior padding 222. The interior padding 222 can be arranged to cover interior surfaces, such as walls, mounts, etc. to protect the provisioned component 110 from damage, for example, during travel of the mobile hospital or during deployment or stowage of the provisioned component 110. The interior padding 222 can be foam, textile-covered stuffing, or another suitable padding material.

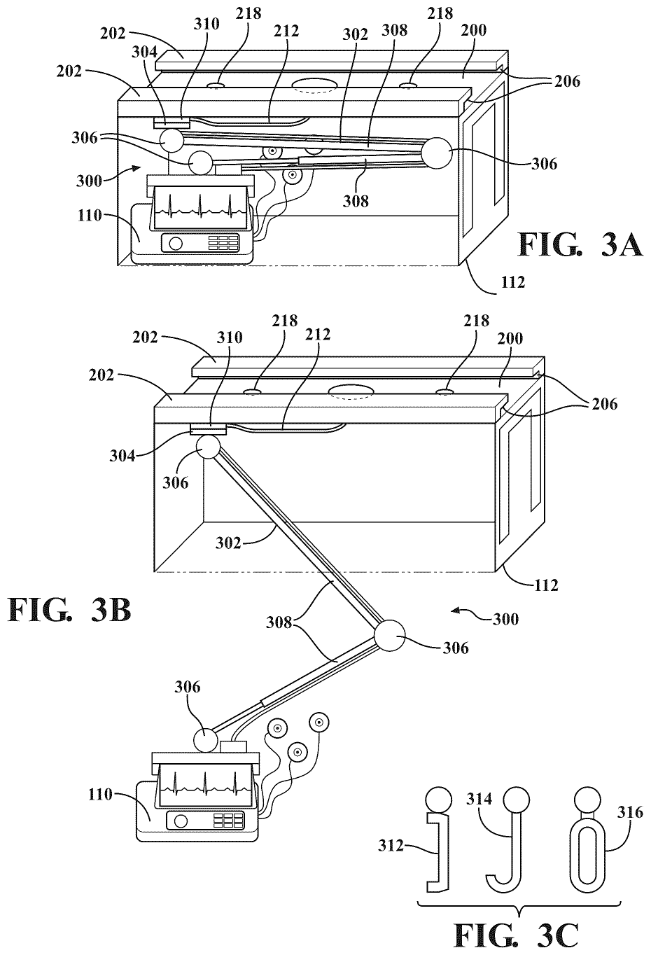

Referring now to FIGS. 3A-5C, in addition to a closure 220 and interior padding 222, in one embodiment, the container 112 also includes a component connector 300 for attaching the provisioned component 110 to the interior space 214. In one arrangement, for example, as shown, the component connector 300 is attached to an opposite side of the outer backwall 200. However, in other arrangements, the component connector 300 is attached to another interior wall of the container 112. The component connector 300 can include various types of mechanical connectors and components. Three examples will be described herein.

Turning now to FIGS. 3A-3C, a first embodiment of a component connector 300 is shown. In the first embodiment, the component connector 300 comprises an articulated arm 302. In one arrangement, the articulated arm 302 is connected to the container 112 via a base 304, which can be a rotating base that mounts the provisioned component 110 to a sidewall of the container 112 or an interior backwall of the container 112. Moreover, in one arrangement, the articulated arm 302 includes rotating joints 306 (e.g., an elbow joint and a wrist joint) and extending arm segments 308. Together with the rotating base 304, the rotating joints 306 and extending arm segments 308 allow the articulated arm 302 to be positioned in many different locations (e.g., at a preferred height and angle) according to the needs of the patient and/or clinical staff. The rotating joints 306 can include horizontal rotating joints and/or vertical rotating joints. The rotating joints 306 can have click locks that hold each arm segment 308 at a set angle engaged from multiple predefined angles and can be advanced forward by moving backward and then forward. Moreover, in one example, the arm segments 308 can extend and contract in length. For example, the arm segments 308 can be telescopic. In one arrangement, the rotating base 304 can be provided with a vibration-damping component 310.

FIG. 3A shows the articulated arm 302 in a retracted position in which the base 304, joints 306, and arm segments 308 are positioned such that the provisioned component 110 is completely stored within the container 112, while FIG. 3B shows the articulated arm 302 in an extended position in which the base 304, joints 306, and arm segments 308 are positioned such that the provisioned component 110 is extended away from (e.g., below) the container 112. Additionally, in one arrangement, the base 304 can include vibration-damping to reduce stress on the provisioned component 110. The vibration-damping component can include a vibration-damping membrane, foam, insulation, etc.

Additionally, to hold the provisioned component 110, the articulated arm 302 can include various types of connectors. Referring now to FIG. 3C, examples of a first arm connector 312, a second arm connector 314, and a third arm connector 316 are shown. The arm connector is removable and interchangeable for holding various provisioned components 110 with, for example, different types of straps. As shown, the first arm connector 312 is a vertical screw clamp, the second arm connector 314 is a high-strength hook, and the third arm connector 316 is an elastic strap or tightened belt. However, the arm connectors can include other components suitable for forming a robust connection between the articulated arm 302 and the provisioned component 110. Additionally, to enable operation of the provisioned component 110, the articulated arm 302 can be substantially hollow to allow the incorporation of the utility 212 (e.g., power cabling, communications cabling, and/or liquid supply lines) to be fed through the articulated arm 302 to the provisioned component 110.

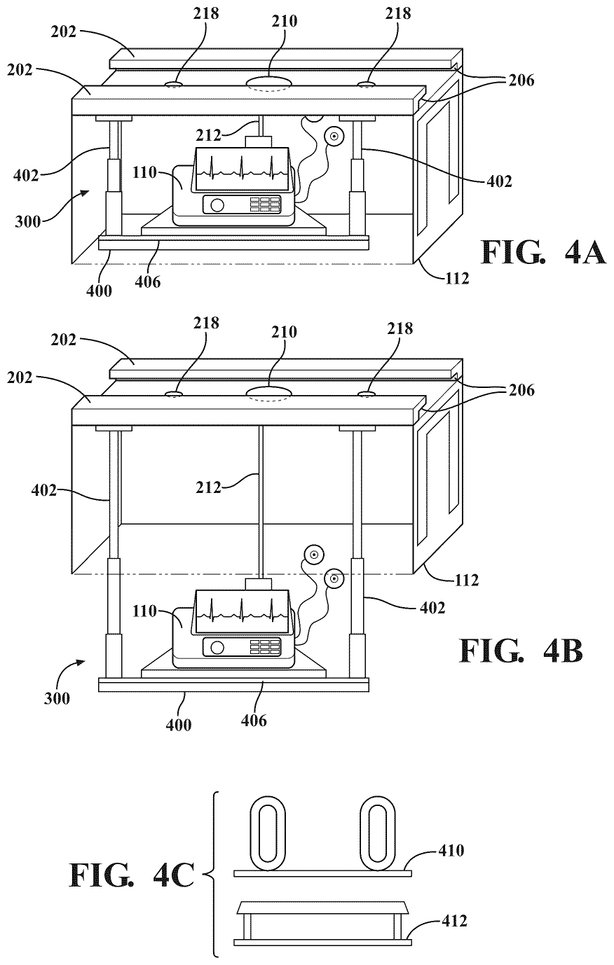

Referring now to FIGS. 4A-4C, a second embodiment of a component connector 300 is shown. In the second embodiment, the component connector 300 includes a platform 400 and arms 402. In one arrangement, the platform 400 supports the provisioned component 110, and the arms 402 connect the platform 400 to the container 112. In one example, the arms 402 are extendable such that the arms 402 can deploy the provisioned component 110 via the platform 400 from a retracted position within the container 112, as shown in FIG. 4A, to a deployed position below the container 112, as shown in FIG. 4B. In one example, the arms 402 are telescopic, while in further arrangements, the arms 402 may be a scissor linkage or another suitable mechanism. In some instances, the platform 400 may be favored over an articulated arm 302 for provisioned components 110 that do not need a wide range of motion but that need more structural support. Moreover, the platform 400 may form a closure of the container 112 such that an outer surface of the platform functions as an exterior surface/door of the container 112. Of course, in further arrangements, the platform may retract beyond a discrete door of the container 112.

Moreover, in one arrangement, the platform 400 may be equipped with vibration-damping. For example, the platform 400 may be equipped with a vibration-damping layer 406 that may be foam, insulation, etc. The vibration-damping layer 406 can be attached to the platform 400 between the platform 400 and the provisioned component 110 to reduce stress transferred to the provisioned component 110. Additionally, to provide more support to the provisioned component 110, the platform 400 can also be equipped with a platform connection. In one embodiment, a first platform connection 408 is shown in FIGS. 4A and 4B. In one arrangement, the first platform connection 408 is a screw clamp system. The screw clamp system can have differently sized screw clamps according to the size and shape of the provisioned component 110. The screw clamp system can help prevent the provisioned component 110 from falling off of the platform 400. Additionally, to provide utilities to the provisioned component 110, the utility 212 can simply drop down through the utility aperture 210 to the provisioned component 110, since the provisioned component 110 has a limited range of motion in this example.

FIG. 4C shows two alternative platform connections. In one example, a second platform connection 410 includes an elastic strap or tightened belt for supporting the provisioned component 110. In another example, a third platform connection 412 includes a restraining plate. The restraining plate can be positioned above the provisioned component 110 and pulled down via securing connectors to secure the provisioned component 110 against the platform 400.

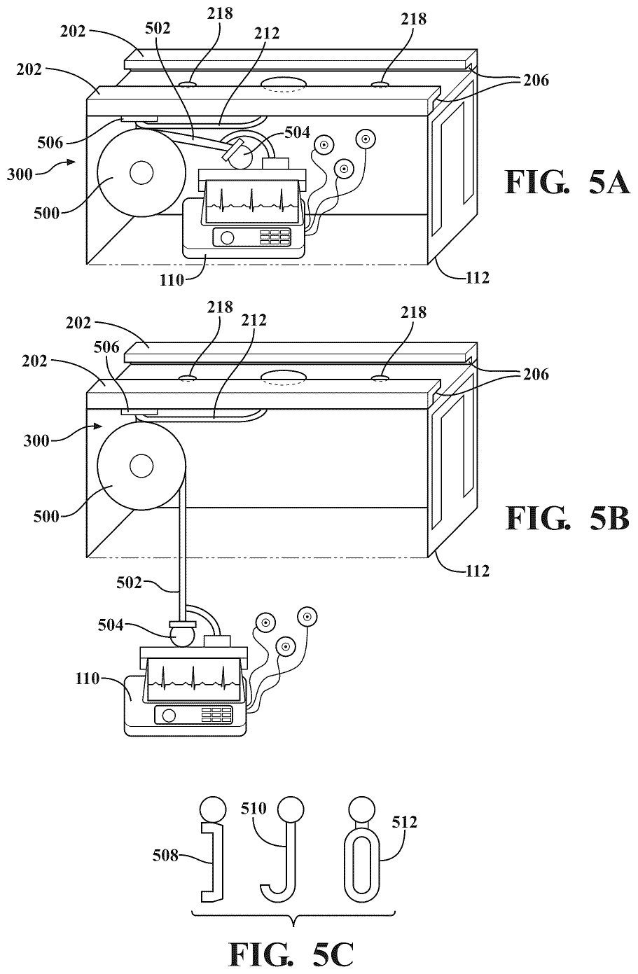

Turning now to FIGS. 5A-5C, a third embodiment of a component connector 300 is shown. In the third embodiment, the component connector 300 includes a reel 500 and a tube 502. The tube 502 is connected to the provisioned component 110 and is configured to support the provisioned component 110 from a retracted position within the container 112, as shown in FIG. 5A, to an extended position below the container 112, as shown in FIG. 5B. The reel 500 is configured to store the tube 502 when the provisioned component 110 is in the retracted position. In one example, the tube 502 is flexible but formed from a rigid material to support the weight of the provisioned component 110. For example, the tube 502 can be formed from rubber with a steel mesh lining. In further arrangements, the tube 502 is formed from a textile, a polymer composite, or another suitable material.

Additionally, the tube 502 can be substantially hollow and configured to provide the utility 212. In the extended position, the provisioned component 110 can be lowered to a specified height via the tube 502. The height can be set by a push-button hold and release mechanism. For connecting the tube 502 to the provisioned component 110, the tube 502 can include one or more joints 504 that enable the provisioned component 110 to be positioned according to the needs of the clinical staff. The joints 504 can be horizontal and/or vertical rotating joints 504. Additionally, in one arrangement, the reel 500 can attach to the container 112 with vibration-damping to reduce stress on the provisioned component 110. The vibration-damping component can include a vibration-damping membrane 506, foam, insulation, etc.

Referring now to FIG. 5C, the tube 502 can also include tube connectors for connecting the tube 502 to the provisioned component 110. Examples of a first tube connector 508, a second tube connector 510, and a third tube connector 512 are shown. The tube connection tips are removable and interchangeable for holding various provisioned components 110 with different types of straps. As shown, the first tube connector 508 is a vertical screw clamp, the second tube connector 510 is a high-strength hook, and the third tube connector 512 is an elastic strap or tightened belt. However, the tube connection tips can include other components suitable for forming a robust connection between the tube 502 and the provisioned component 110. As an additional note, while the provisioned components 110 are illustrated as being connected via various types of devices, in further arrangements, the provisioned components 110 may be connected directly to a backwall, sidewall, or even front wall of the container 112 via one or more of the various connectors described herein.

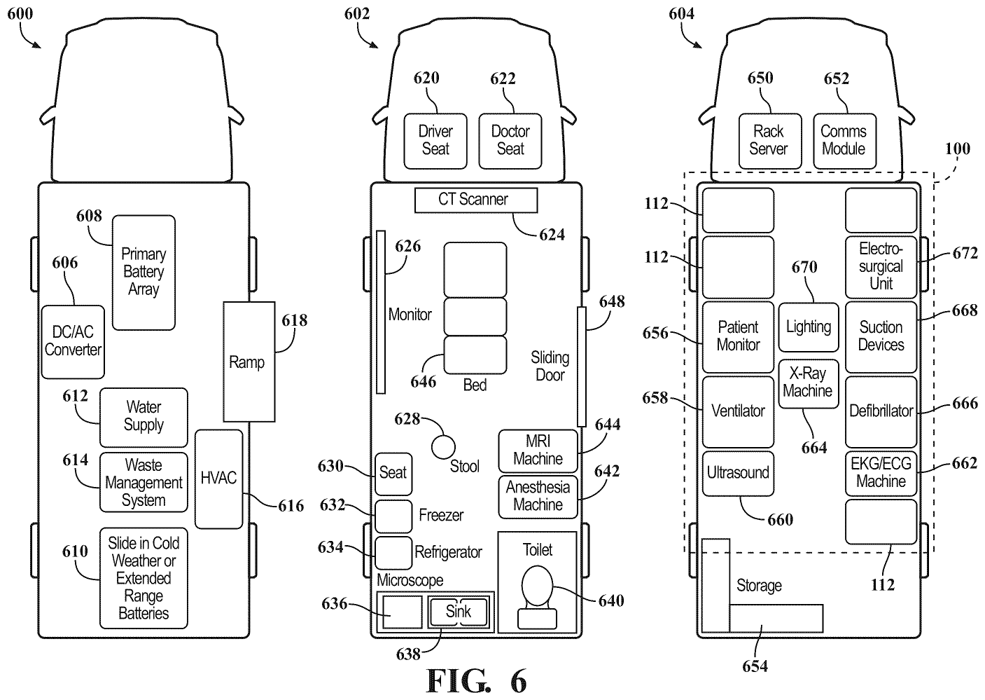

Turning now to FIG. 6, examples of an underbody 600, a floor 602, and a ceiling 604 of a mobile hospital are shown. Provided on the underbody 600, in one arrangement, the mobile hospital includes a DC/AC converter 606, a primary battery array 608, and slide-in cold weather or extended range batteries 610 for providing power to one or more other components of the mobile hospital. The underbody 600 also includes, in one example, a water supply 612, a waste management system 614, and an HVAC system 616 to support day-to-day operations of the mobile hospital. The underbody 600 can also be equipped with a ramp 618 (or a lift 116, as mentioned above in connection with FIG. 1).

On the floor 602 of the mobile hospital, for example, within a cab of the mobile hospital, the mobile hospital can also include a driver seat 620 for a driver of the mobile hospital and a doctor seat 622 for a doctor or another member of the clinical staff. The floor 602 can also be equipped with other components that support day-to-day operations of the mobile hospital, including, for example, a CT scanner 624, a monitor 626, a stool 628, a seat 630 (e.g., a nurses seat), a freezer 632, a refrigerator 634, a microscope 636, a sink 638, a toilet 640, an anesthesia machine 642, an MRI machine 644, a bed 646 (e.g., for patients), and a sliding door 648.

On the ceiling 604 of the mobile hospital, the mobile hospital can also include a rack server 650 and a communications module 652 to support online connection of the mobile hospital and the clinical staff. In addition to storage 654 (e.g., storage for medical supplies), the ceiling 604 also includes the system 100. As noted above, the system 100 includes one or more containers 112 for storing provisioned components 110. The provisioned components 110 can include, for example, a patient monitor 656, a ventilator 658, an ultrasound 660, an EKG/ECG machine 662, an X-Ray machine 664, a defibrillator 666, suction devices 668, lighting 670, and an electrosurgical unit 672.

The embodiments described herein provide the advantage of providing a modular system for equipment, such as medical-based equipment, that is customizable in relation to position and form. For example, the modular system provides the advantage of customizability of the location and deployment of medical equipment according to the needs of a patient, clinical staff, maintenance, and other factors, thereby providing a robust system that supports a wide variety of configurations.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ,” as used herein, refers to and encompasses any and all possible combinations of one or more of the associated listed items. As an example, the phrase “at least one of A, B, and C” includes A only, B only, C only, or any combination thereof (e.g., AB, AC, BC, OR ABC).

As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some examples, “substantially” can include being within normal manufacturing tolerances.

In this description, uses of “front,” “forward” and the like, and uses of “rear,” “rearward” and the like, refer to the longitudinal directions of the vehicle. “Front,” “forward,” and the like refer to the front (fore) of the vehicle, while “rear,” “rearward” and the like refer to the back (aft) of the vehicle. Uses of “side,” “sideways,” “transverse” and the like refer to the lateral directions of the vehicle, with “driver's side” and the like referring to the left side of the vehicle, and “passenger side” and the like referring to the right side of the vehicle.

Aspects herein can be embodied in other forms without departing from the spirit or essential attributes thereof. Accordingly, reference should be made to the following claims, rather than to the foregoing specification, as indicating the scope thereof.

What is claimed is:

1. A modular system for storing and deploying provisioned components within a vehicle, the modular system comprising:
a container having:
(i) an interior space for accommodating a provisioned component,
(ii) a component connector for attaching the provisioned component to the interior space,
(iii) a modular mount integrated with an outer backwall of the container, and
(iv) a utility aperture; and
a modular connector for securing the container to the vehicle via the modular mount.

2. The modular system of claim 1, wherein the container is a box with at least five sides that are integrated as a unified structure and an opening that supports a selectively movable closure for enclosing the provisioned component within the interior space.

3. The modular system of claim 1, wherein the utility aperture is an opening in the container for passing at least one utility into the interior space, including one or more of electric, water, pneumatics, and communication, and
wherein the utility aperture is formed from at least one conduit extending through the container to a service opening of the vehicle.

4. The modular system of claim 1, wherein the modular mount is provided on the outer backwall to interface with the modular connector, the modular mount defining a recessed channel for receiving the modular connector.

5. The modular system of claim 1, wherein at least one of the modular connector and the modular mount have integrated shock dampening including rubberized spacers affixed to the modular connector along rails, and wherein the modular mount interfaces with the modular connector.

6. The modular system of claim 1, wherein the modular mount is at least semi-continuous along the outer backwall of the container and defines one of: a single channel or a dual channel for receiving at least one of the modular connector.

7. The modular system of claim 1, wherein the component connector is a static connector that statically mounts the provisioned component to one of a sidewall of the container or an interior backwall of the container opposing the outer backwall,
the component connector including one of a clamp, a strap, a hook, and a retaining plate.

8. The modular system of claim 1, wherein the component connector supports a platform for lowering the provisioned component from the interior space of the container.

9. The modular system of claim 1, wherein the component connector secures an articulated arm via a rotating base with a click lock that locks a selected angle engaged from multiple predefined angles.

10. The modular system of claim 1, wherein the modular connector is integrated with a ceiling of the vehicle.

11. The modular system of claim 1, wherein the modular connector is integrated with a floor of the vehicle.

12. The modular system of claim 1, wherein the modular connector is integrated with a sidewall of the vehicle.

13. An apparatus for storing and deploying provisioned components, the apparatus comprising:
a container defining a utility aperture and an interior space for accommodating a provisioned component;
a component connector for attaching the provisioned component to a surface of the container;
a modular mount integrated with an outer backwall of the container; and
a modular connector for securing the container to a structure via the modular mount.

14. The apparatus of claim 13, wherein the structure is one of a ceiling of a building, a wall of a building, and a floor of a building.

15. The apparatus of claim 13, wherein the modular mount defines at least one channel, wherein the modular connector includes at least one rail, and wherein the container is secured to the surface by sliding the container along the modular connector such that the at least one channel mates with the at least one rail.

16. The apparatus of claim 13, wherein the modular mount is at least semi-continuous along the outer backwall of the container and defines one of: a single channel or a dual channel for receiving at least one of the modular connector.

17. A device for storing and deploying provisioned components within a vehicle, the device comprising:
a container defining a utility aperture and an interior space for accommodating a provisioned component and having:
a component connector for attaching the provisioned component to the interior space, and
a modular mount that is at least semi-continuously integrated along an exterior surface of the container and defines at least one channel; and
a modular connector having at least one rail that mates with the at least one channel for detachably securing the container to the vehicle via the modular mount.

18. The device of claim 17, wherein at least one of the modular connector and the modular mount have integrated shock dampening including rubberized spacers affixed to the modular connector along rails wherein the modular mount interfaces with the modular connector.

19. The device of claim 17, wherein the component connector is a static connector that statically mounts the provisioned component to one of a sidewall of the vehicle or an interior backwall of the vehicle opposing an outer backwall of the container,
the component connector including one of a clamp, a strap, a hook, and a retaining plate.

20. The device of claim 17, wherein the modular connector is integrated with one of a ceiling of the vehicle, a sidewall of the vehicle, and a floor of the vehicle.
